(19) United States
(12) Patent Application Publication
(10) Pub. No.: US 2005/0086200 A1
(43) Pub. Date: Apr. 21, 2005

(54) Presentation system and method

(76) Inventors: Jared Kirkman, Jacksonville, FL (US); Todd R. Krombholz, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/660,184

(22) Filed: Sep. 11, 2003

Related U.S. Application Data
(60) Provisional application No. 60/415,260, filed on Sep. 30, 2002.

(51) Int. Cl. G06F 7/00

(52) U.S. Cl. 707/2

(57) ABSTRACT

The present invention relates to presentations, and, more specifically, the present invention relates to a presentation system that allows the user to define the order of information to be presented by selecting data units from an index to form a presentation pick list, and that allows a user to select the data units from a plurality of data unit types, and a presentation method of presenting the same.

### RELATED PATENT APPLICATIONS

This patent application claims priority of a provisional application, U.S. Ser. No. 60/415,260 which was filed on Sep. 30, 2002.

### FIELD OF THE INVENTION

The present invention relates to presentations, and, more specifically, the present invention relates to a presentation system that allows the user to define the order of information to be presented by selecting data units from an index to form a presentation pick list, and that allows a user to select the data units from a plurality of data unit types, and a presentation method of presenting the same.

### BACKGROUND OF THE INVENTION

Systems for generating static presentations are known. However, once the presentation is set, it is difficult to change the order of the information presented. For example, the static presentation does not allow for variation of the elements presented in the presentation in the midst of a presentation without perusing through the elements of the presentation, or without exiting the presentation to reorder the presentation.

Difficulties in ordering, or reordering, presentations are particularly evident when video or audio files are to be included in the presentation. Existing static presentation methodologies lack simplistic mechanisms to incorporate audio or video files into the presentation, and present further difficulties when presentations including audio or video files are to be varied during the presentation.

Further, existing static presentation methodologies do not provide simplistic mechanisms to set up and order presentation, particularly when those presentations are to include audio or video files. For example, existing presentations may provide different views, which the user must vary between in order to perform ordering of the presentation, such as a slide outline view wherein a user can drag and drop to order the slide presentation, a slide show view wherein a user can view the existing presentation in its presented format, and the like.

Thus, there remains a need in the art for a presentation system that allows the user to simplistically customize presentation elements, including audio and video elements, such as to be presented to different audiences or for different reasons.

### SUMMARY OF THE INVENTION

The present invention relates to a presentation system, comprising:
a plurality of data units, including a plurality of data types;
a selector that provides access to said plurality of data units and that receives selection, from a user in a single user action, of ones of said plurality of data units;
an indexer communicatively connected to said selector, wherein said indexer indexes the user selected ones of said plurality of data units into a primary index to form a presentation;
a launcher, wherein selection of said launcher by the user transfers the primary index to a final index accessible to the user throughout the presentation, and wherein selection of said launcher by the user launches the presentation;
at least one secondary index accessible to the user throughout the presentation and comprising a plurality of secondary data units, wherein selection by the user of an indicator transfers the presentation from the final index to the secondary index, and wherein, upon selection of ones of the secondary data units, the selected ones of the secondary data units are presented in the presentation, and wherein, upon completion of presenting the selected ones of the secondary data units, the presentation returns to the final index.

The present invention further relates to a presentation method comprising:
granting a user access to a universal data unit list;
receiving a plurality of selections from the universal data unit list from the user;
indexing the selected data units into a presentation index;
receiving a presentation launch instruction from the user;
launching the presentation in accordance with said receiving launch instruction;
providing access by the user from a single user action to the presentation index for a duration of the presentation;
temporarily suspending presentation of the presentation index in favor of a secondary presentation from a sub-index, in accordance with a received user suspension instruction; and
automatically returning to the presentation from the secondary presentation following completion of said temporarily suspending.

### DESCRIPTION OF THE DRAWINGS

FIG. 1 is a box diagram of the presentation system of the present invention.

FIG. 2 is a graphical representation of a data unit index.

FIG. 3 is a flow diagram of the presentation method of the present invention.

### DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical presentation system and method. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure hereinbelow is directed to all such variations and modifications to configurations for presentation systems and methods as are known, and as will be apparent, to those skilled in the art.

The present invention relates to a presentation system that allows the user to define the order of information to be presented by selecting data units from an index to form a presentation pick list. The present invention relates to an index of data units, which index allows for incorporation of video and/or audio data units, and which index allows a user to vary from the presentation as initially ordered, such as during the presentation, and to return to the presentation, as ordered, at the point of departure, upon completion of the departure.

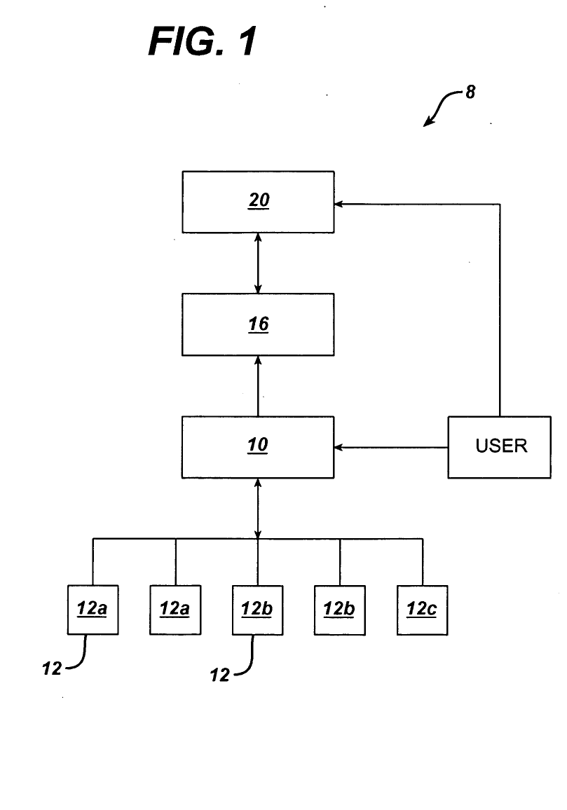

FIG. 1 illustrates a presentation system 8 in accordance with the present invention. The presentation includes a data unit selector 10 that provides user access to a plurality of data units 12, which plurality of data units may include a plurality of data unit types 12a, 12b, 12c. The selector may be resident as programming associated with a processor, as will be apparent to those skilled in the art. The data units may be selected from, for example, slide data, pictoral data, motion video data, audio data, textual data and the like. As used herein, a “data unit” refers to a discrete electronic file, and thus a data unit may contain textual information, such as a text slide or a series of text slides, graphical information, such as charts, graphs and the like, video information, such as photographs, video clips, still or moving animations and the like, audio information, such as music, narration, sound effects and the like, and/or combinations thereof. For example, a representative data unit might include a single chart or photograph, or may include a series of different media, such as photograph of a given product, followed by text and graphical information relating to the presentation topic, followed by a video clip of the product in use. Data units may be created using known software such as Word, Powerpoint, Excel, Macromedia Director, Adobe Photoshop and Photoedit, Microsoft Moviemaker, Avid, Quicktime, Flash, Flax, Swift 3D, and the like, for example. Thus, the programming of the present invention is accepting to a plurality of data types and programming languages, as will be apparent to those skilled in the art.

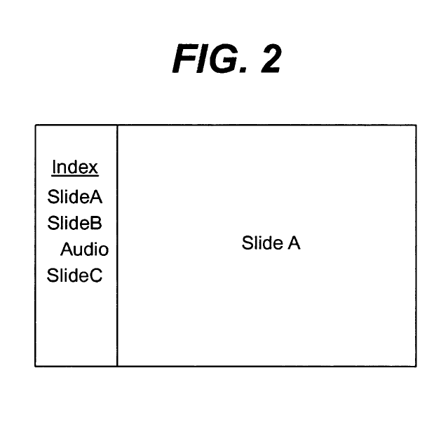

The selector 10 is communicatively connected to an indexer 16 which indexes the selected data in a predetermined sequence. The indexer may be resident as programming associated with a processor, as will be apparent to those skilled in the art. For example, data may be entered into the presentation in the order that a user selects the data units by a user action, such as by a single user action, such as by the user single clicking on the data units. The indexer places the selected data units into an ordered index, which ordered index may include sub-indexes, which sub-indexes may not form part of the principal presentation unless the user selects the sub-index, such as during the presentation. In an embodiment of the present invention, the index formed by the indexer may be available at all times to a user, including during a presentation, such as by provision of a split or framed screen evidencing the presentation on a portion of the split screen, and evidencing the index on a second portion of the split screen, or, for example, by use of a single click or single keystroke during the presentation to recall the index, such as into a split screen. Such a split, or framed, screen, including a data unit index, is illustrated in FIG. 2.

The indexer 16 may include a contents indexer and a final indexer. During assembly of the presentation, the data units may be sorted into groups and may be selected for assembly into the contents indexer. Data items on the contents indexer may have associated therewith a radio button that either includes or excludes the item. Once an item is selected for inclusion in the final presentation, the associated data units are placed in a run list in accordance with the then-current version of the index in the contents indexer. Once all desired data items have been selected and indexed, launching may activate the final indexer, and may launch the presentation in accordance with the index in the final indexer.

The presentation system may further include a launcher 20, which launcher 20, upon launch, may execute programming, such as a series of programmed “go to” commands, to present the selected data units in the selected sequence of the run list. The launcher may sequence through the index in accordance with the run list automatically, or in accordance with, for example, a user depressing a key, such as the up or down key, to move to a subsequent data unit in the presentation. Alternatively, a user may go back, or otherwise vary the presentation index sequence by depressing a different key, which variation in the index sequence may create a secondary run list, which secondary run list may preferably be titled and stored separately from the primary run list. The secondary run list may preferably additionally include a reference to the point of departure from the primary run list, thereby allowing the launcher to return to the primary run list at the point of departure, such as upon receipt of a return instruction from the user, such as by depressing of a “hot key” by the user. Thus, upon launch of the secondary run list, the primary run list may be retained for easy access by the launcher, such as in a cache memory associated with the presentation system.

In addition to the content indexer and the final indexer, the indexer may include a plurality of index shells, wherein each shell is presented as a single view, and wherein each shell provides access to the presentation within that shell, and the indexes of other data units and secondary presentations. The indexer may allow the user to open a new secondary shell on the primary presentation shell. In the secondary shell, the user may navigate to other available data units, such as from a universal data unit index, or to available secondary indexes, and launch those other available data units, or those secondary indexes. Upon completion of running the other data units, or the secondary index, the secondary shell may close, and the presentation may return to the primary shell. This return to the primary shell may occur automatically upon completion of the secondary shell, or may occur at the instruction of the user, such as by the user depressing a “hot key”.

In additional embodiments of the present invention, a “hot key” may be employed to jump to a secondary shell, or a secondary run list. For example, a primary index may include the main presentation of the user, while a “back up” secondary run list, such as a secondary run list that the user anticipates may be responsive to questions from the audience to the presentation, may be accessible to the user by depressing a predetermined hot key. Upon completion of the secondary run list, the presentation may automatically, or at the user's instruction, return to the primary run list. Of note, in the present invention, the plurality of run lists, the plurality of indexes, and/or the plurality of shells may operate in series or in parallel.

The presentation system of FIG. 1 further includes storage for the presentation after the presentation is indexed by the indexer. This storage may include, for example, a cache, a RAM or a ROM, a hard or floppy disk, a remote storage connected in the presentation system by a network such as, for example, the internet.

The presentation may be displayed, for example, using a PC running an operating system, such as, but not limited to Macintosh OS or Windows. The presentation may be displayed on, for example, a computer screen, a multimedia device, a computer networked device, and/or combinations thereof. Suitable computer networks may include closed networks and the Internet, for example.

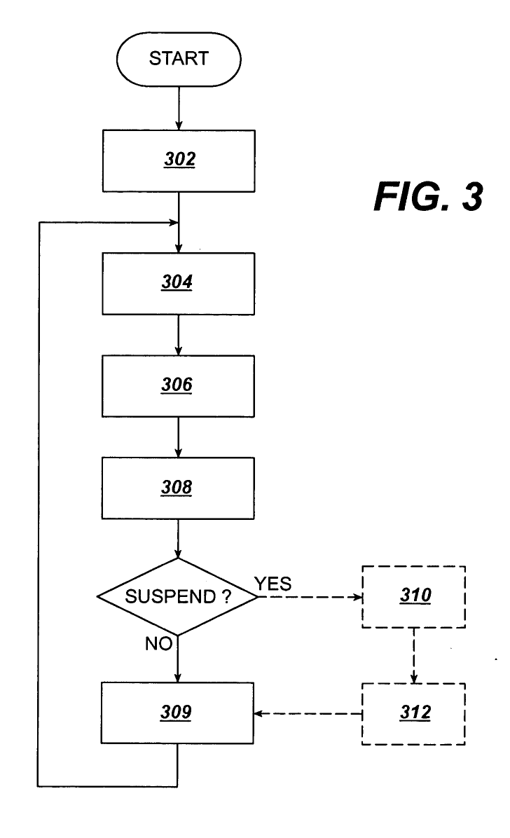

FIG. 3 is a flow diagram illustrating a presentation method in accordance with the present invention. At step 302, the user is granted access to a universal data unit list. At step 304, a plurality of selections from the data unit list is received from the user, and those selected data units are indexed into a presentation index at step 306. The presentation is launched at step 308, in accordance with receipt of a launch instruction. At this point the primary presentation 309 may be presented by the user. At optional step 310, the primary presentation is temporarily suspended in favor of a secondary presentation. The secondary presentation may be a single selection or a plurality of selections from the universal data unit list, from a sub-index, or a secondary run list, in accordance with a received user instruction. Optional step 310 may include, for example, granting access to the universal index, or access to a predetermined sub-index, or secondary run list. At optional step 312, the user is automatically returned to the primary presentation 311, following completion of the secondary presentation and temporary suspension. The method of the present invention may additionally include steps wherein the user formulates the secondary presentation in a manner similar to that described hereinabove with respect to the primary presentation.

In the foregoing description, numerous specific details have been set forth to provide a thorough understanding of the present invention. However, the present invention may be practiced without some of these specific details. In other instances, well known process steps have not been described in detail in order not to obscure the present invention.

1. A presentation system, comprising:
a plurality of data units, including a plurality of data types;
a selector that provides access to said plurality of data units and that receives selection, from a user in a single user action, of ones of said plurality of data units;
an indexer communicatively connected to said selector, wherein said indexer indexes the user selected ones of said plurality of data units into a primary index to form a presentation;
a launcher, wherein selection of said launcher by the user transfers the primary index to a final index accessible to the user throughout the presentation, and wherein selection of said launcher by the user launches the presentation;
at least one secondary index accessible to the user throughout the presentation and comprising a plurality of secondary data units, wherein selection by the user of an indicator transfers the presentation from the final index to the secondary index, and wherein, upon selection of ones of the secondary data units, the selected ones of the secondary data units are presented in the presentation, and wherein, upon completion of presenting the selected ones of the secondary data units, the presentation returns to the final index.

2. The presentation system of claim 1, wherein the final index comprises a plurality of sub-indexes, wherein said at least one secondary index is selected from the plurality of sub-indexes.

3. The presentation system of claim 1, wherein the accessibility to the final index throughout the presentation comprises a split-screen of the presentation.

4. The presentation system of claim 1, wherein said secondary index comprises a departure reference to a point of departure from the final index.

5. The presentation system of claim 1, wherein said selector comprises programming associated with a processor.

6. The presentation system of claim 1, wherein each of the data units comprises at least one selected from the group consisting of textual information, graphical information, video information, audio information, and combinations thereof.

7. The presentation system of claim 1, further comprising a storage for the presentation after the presentation is indexed by said indexer.

8. The presentation system of claim 1, wherein said storage comprises at least one selected from the group consisting of a cache, a RAM, a ROM, a hard disk, a floppy disk, and a remote storage.

9. A presentation method comprising:
granting a user access to a universal data unit list;
receiving a plurality of selections from the universal data unit list from the user;
indexing the selected data units into a presentation index;
receiving a presentation launch instruction from the user;
launching the presentation in accordance with said receiving launch instruction;
providing access by the user from a single user action to the presentation index for a duration of the presentation;
temporarily suspending presentation of the presentation index in favor of a secondary presentation from a sub-index, in accordance with a received user suspension instruction; and
automatically returning to the presentation from the secondary presentation following completion of said temporarily suspending.
